(19) United States
(12) Patent Application Publication
(10) Pub. No.: US 2007/0297091 A1
(43) Pub. Date: Dec. 27, 2007

(54) Patterned magnetic recording medium and method of manufacturing the same

(75) Inventors: Sang-jun Choi, Yongin-si (KR); Jung-hyun Lee, Yongin-si (KR); Hoon-sang Oh, Seongnam-si (KR); Bum-seok Seo, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/700,077

(22) Filed: Jan. 31, 2007

(30) Foreign Application Priority Data
Jun. 27, 2006 (KR) 10-2006-0058095

(51) Int. Cl. G11B 23/00

(52) U.S. Cl. 360/131; 977/762

(57) ABSTRACT

A patterned magnetic recording medium and a method of manufacturing the same are provided. The patterned magnetic recording medium includes a plate, a plurality of nanowires formed vertically on the plate, and a magnetic layer patterned on the nanowires. The magnetic layer protrudes in areas corresponding to the nanowires.

### CROSS-REFERENCE TO RELATED PATENT APPLICATION

This application claims priority from Korean Patent Application No. 10-2006-0058095, filed on Jun. 27, 2006, in the Korean Intellectual Property Office, the disclosure of which is incorporated herein in its entirety by reference.

### BACKGROUND OF THE INVENTION

1. Field of the Invention

Recording mediums and methods of manufacturing the same consistent with the present invention relate to a patterned magnetic recording medium and a method of manufacturing the same, and more particularly, to a patterned magnetic recording medium having a magnetic layer patterned using nanowires and a method of manufacturing the patterned magnetic recording medium.

2. Description of the Related Art

In the field of magnetic recording, many researches are being conducted to increase the recording density. To increase the recording density of recording media, the bit size of the recording media should be reduced. However, when the magnetic grain size of related art magnetic recording media using a bulk magnetic film is reduced below a critical value, a supperparamagnetic effect occurs, which obstructs the increase in recording density (i.e., the number of bits per unit area). For this reason, patterned magnetic recording media are used to further increase the recording density. In a related art patterned magnetic recording medium, magnetic grains are structurally isolated from each other.

The related art patterned magnetic recording medium includes a patterned magnetic layer having a pattern size smaller than the magnetic domain size of a continuous magnetic layer. The related art patterned magnetic recording medium is formed using an etching process. For example, the patterned magnetic recording medium is formed using electron-beam lithography, holographic lithography, or nanoimprint lithography.

However, the reduction of the magnetic domain size in the related art magnetic recording medium is limited because of the restrictions of the etching process. Further, the manufacturing costs of the related art magnetic recording medium are high.

### SUMMARY OF THE INVENTION

The present invention provides a patterned magnetic recording medium that can be manufactured through a process using nanowires, and a method of manufacturing the patterned magnetic recording medium.

According to an aspect of the present invention, there is provided a patterned magnetic recording medium including: a plate; a plurality of nanowires formed on the plate; and a magnetic layer patterned on the nanowires, the magnetic layer protruding in areas corresponding to the nanowires.

The patterned magnetic recording medium may further include a buffer layer between the plate and the nanowires.

The buffer layer may be patterned along tracks of the patterned magnetic recording medium, and the nanowires may be formed on the patterned buffer layer along the tracks.

The nanowires may have flattened leading ends.

The patterned magnetic recording medium may further include a capping layer formed on the magnetic layer for protecting the magnetic layer.

According to another aspect of the present invention, there is provided a method of manufacturing a patterned magnetic recording medium, the method including: forming a plurality of nanowires on a plate; and forming a magnetic layer on the nanowires.

The forming of the nanowires may include: forming a buffer layer on the plate; forming trenches in a top surface of the buffer layer in a pattern; growing one or more of the nanowires in each of the trenches; and removing nanowires grown on the buffer layer outside the trenches.

The forming of the nanowires may include flattening leading ends of the nanowires after the nanowires are grown.

The nanowires may be ZnO nanowires, carbon nanotubes, or silicon nanotubes.

The magnetic layer may be formed of an alloy containing at least one magnetic element and at least one non-magnetic element, the magnetic element including Fe and Co, the non-magnetic element including Pt and Cr.

### BRIEF DESCRIPTION OF THE DRAWINGS

The patent or application file contains at least one drawing executed in color. Copies of this patent or patent application publication with color drawings will be provided by the Office upon request and payment of the necessary fee.

The above and other features and aspects of the present invention will become more apparent by describing in detail exemplary embodiments thereof with reference to the attached drawings in which:

FIG. 1 is a schematic sectional view of a patterned magnetic recording medium according to an exemplary embodiment of the present invention;

FIG. 2 is a schematic sectional view of a patterned magnetic recording medium according to another exemplary embodiment of the present invention;

FIGS. 3A through 3E are views for illustrating a method of manufacturing the patterned magnetic recording medium of FIG. 1;

FIGS. 4A and 4B show intermediate results obtained after processes of FIGS. 3C and 3D, respectively;

FIGS. 5A through 5E are views for illustrating a method of manufacturing the patterned magnetic recording medium of FIG. 2; and

FIG. 6 shows an intermediate result obtained after a process of FIG. 5D is finished for the patterned magnetic recording medium.

### DETAILED DESCRIPTION OF EXEMPLARY EMBODIMENTS THE INVENTION

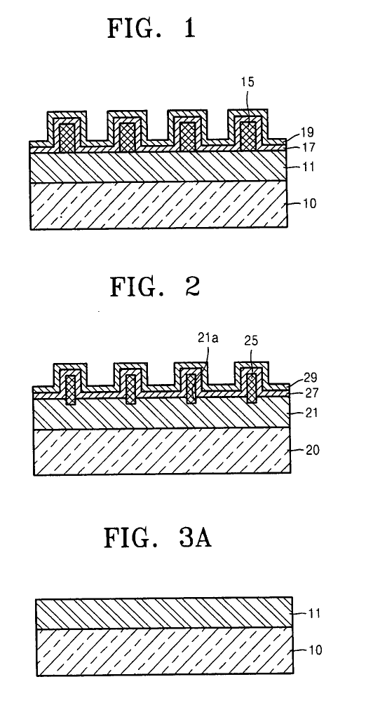

FIG. 1 is a schematic sectional view of a patterned magnetic recording medium according to an exemplary embodiment of the present invention.

Referring to FIG. 1, the patterned magnetic recording medium includes a plate 10, a buffer layer 11 stacked on the plate 10, a plurality of nanowires 15 formed on the buffer layer 11 vertically, a magnetic layer 17 formed on the nanowires 15, and a capping layer 19 formed on the magnetic layer 17. The present invention is characterized in that the magnetic layer 17 is patterned by the nanowires 15 since it is formed over the vertically standing nanowires 15.

The plate 10 is formed of glass or aluminum as a magnetic recording medium substrate. Usually, the plate 10 has a disk shape. The buffer layer 11 is formed on the plate 10 to facilitate the growth of the nanowires 15. The buffer layer 11 may be formed of silicon. The capping layer 19 prevents the magnetic layer 17 from being damaged by a magnetic head (not shown).

The nanowires 15 are uniformly grown on the buffer layer 11. The nanowires 15 have a diameter of several nanometers (nm) to several tens of nanometers (nm). The nanowires 15 can have a diameter of about 10 nm to 50 nm. The nanowires 15 have a length of several tens to several hundreds of nanometers. The nanowires 15 are leveled and thus have a constant height. The nanowires 15 may be ZnO nanowires, carbon nano tubes, or silicon nano tubes.

The magnetic layer 17 is formed of a ferromagnetic material having a high coercive force. The magnetic layer 17 may be formed of an alloy including a magnetic substance (e.g., Fe or Co) and a non-magnetic substance (e.g., Pt or Cr). For example, the magnetic layer 17 is formed of an alloy selected from the group consisting of CoPt, FePt, CoCr, FeCr, and FeCoCr.

The magnetic layer 17 is stacked on the buffer layer 11 and the nanowires 15 grown on the buffer layer 11 vertically, such that the magnetic layer 17 is patterned into magnetic dot shapes by the nanowires 15. In detail, the magnetic layer 17 formed by covering the buffer layer 11 and the nanowires 15 with a magnetic material, such that the magnetic layer 17 protrudes at the nanowires 15 and thus forms magnetic domains divided by the protruded portions. Here, portions of the magnetic layer 17 placed on leading ends of the nanowires 15 are used for magnetic recording. That is, the magnetic layer 17 is vertically bent each time at the nanowires 15, and the portions of the magnetic layer 17 placed on the leading ends of the nanowires 15 are used for magnetic recording as magnetic dots.

Only some portions of the magnetic domains formed by the magnetic layer 17 are used for magnetic recording. That is, only the portions of the magnetic layer 17 placed on the leading ends of the nanowires 15 are used for magnetic recording. Therefore, the size of the nanowires 15 (i.e., the diameter of the nanowires 15) may determine the size of magnetic domains used for magnetic recording. In other words, the recording density of the magnetic recording medium can be controlled by adjusting the size of magnetic domains using the size of nanowires 15. In the present invention, the nanowires 15 have a diameter from several nanometers to several tens of nanometers. Thus, the magnetic domains can be formed to have a size from several nanometers to several tens of nanometers, thereby attaining a high recording density such as 300 GB/inch².

Meanwhile, for uniform magnetic recording, the magnetic domains should be uniformly formed. Therefore, the nanowires 15 should be uniformly formed at least over the bit size of the patterned magnetic recording medium.

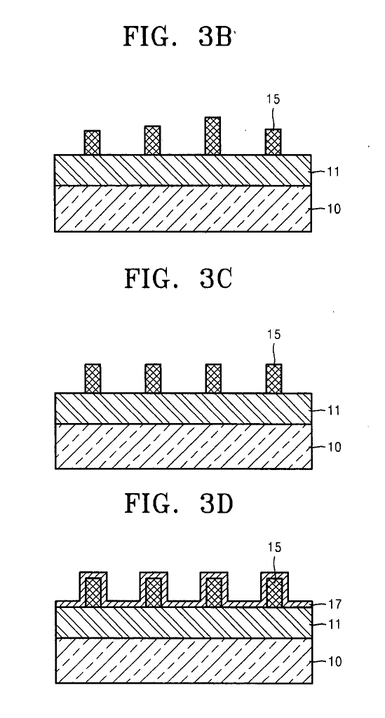

FIG. 2 is a schematic sectional view of a patterned magnetic recording medium according to another exemplary embodiment of the present invention.

Referring to FIG. 2, the patterned magnetic recording medium includes a plate 20, a buffer layer 21 stacked on the plate 20, a plurality of nanowires 25 formed on the buffer layer 21 vertically, a magnetic layer 27 formed on the nanowires 25, and a capping layer 29 formed on the magnetic layer 27. The current exemplary embodiment is substantially the same as the exemplary embodiment shown in FIG. 1 except that the buffer layer 21 is formed with trenches 21a so as to uniformly grow the nanowires 25. Thus, descriptions of the same elements will be omitted. The difference will now be described in detail.

In the current exemplary embodiment, the buffer layer 21 is patterned along tracks of the patterned magnetic recording medium for forming the trenches 21a. When the patterned magnetic recording medium has a disk shape like a typical magnetic recording medium, the tracks have a circular shape. The nanowires 25 are formed at the trenches 21a of the buffer layer 21. Referring to FIG. 2, although a single nanowire 25 is formed for each trench 21a in a width direction (in case of a circular trench, the radial direction) of the trench 21a, the present invention is not limited to this configuration. A plurality of nanowires 25 can be formed for each trench 21a in the width direction of the trench 21a.

Meanwhile, since it is relatively easy to grow the nanowires 25 uniformly in one direction, the nanowires 25 are uniformly formed along predetermined tracks of the patterned magnetic recording medium. Since the magnetic layer 27 covers the buffer layer 21 and the nanowires 25, the magnetic layer 27 is patterned in the same fashion as the buffer layer 21. Therefore, portions of the magnetic layer 27 placed on leading ends of the nanowires 25 are uniformly arranged along the tracks. As a result, according to the patterned magnetic recording medium of the current exemplary embodiment, it is relatively easy to have the magnetic domains uniformly arranged along the tracks.

A method of manufacturing a patterned magnetic recording medium will now be described according to an exemplary embodiment of the present invention. In describing the method, detailed descriptions of typical semiconductor manufacturing technologies will be omitted.

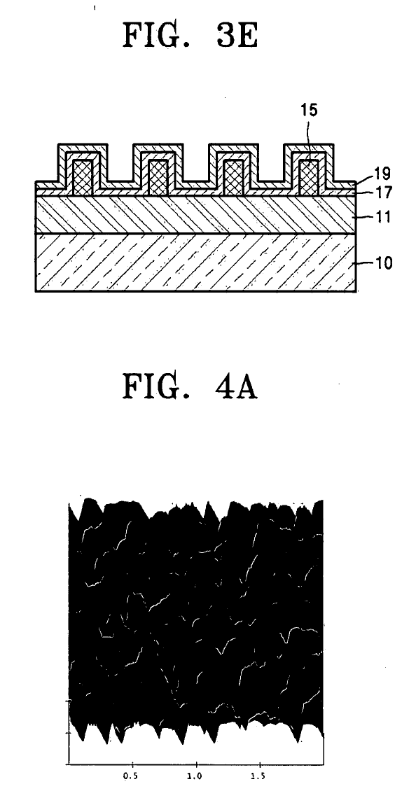

FIGS. 3A through 3E are views for illustrating a method of manufacturing the patterned magnetic recording medium of FIG. 1, according to an exemplary embodiment of the present invention.

Referring to FIG. 3A, a plate 10 is prepared as a base substrate of a magnetic recording medium, and a buffer layer 11 is deposited on the plate 10. The plate 10 may be formed of quartz glass or aluminum. The buffer layer 11 may be formed of a material suitable for growing nanowires, such as silicon.

Referring to FIG. 3B, nanowires 15 are grown on the buffer layer 11 vertically. The nanowires 15 may be one of ZnO nanowires, carbon nanotubes, and silicon nanotubes. In the current exemplary embodiment, the nanowires 15 are ZnO nanowires.

The nanowires 15 may be grown on the buffer layer 21 by atomic layer deposition (ALD) or plasma enhanced chemical vapor deposition (PECVD). In case of the ALD, a precursor such as Et2 (an ethyl group) is deposited, and oxygen (O₂) is injected while the precursor is deposited in order to grow ZnO nanowires. In this method, deposition can be performed cyclically with atomic layer unit, such that the length of the nanowires 15 can be adjusted precisely.

Referring to FIG. 3C, the grown nanowires 15 are flattened by trimming. For this flattening, ion milling (using Ar plasma) or laser trimming is used.

Referring to FIG. 3D, a magnetic material is deposited on the buffer layer 11 and the trimmed nanowires 15 to form a magnetic layer 17. The magnetic material may be one selected from alloys containing a magnetic element (e.g., Fe and Co) and a non-magnetic element (e.g., Pt and Cr). For example, the magnetic material may be one selected from the group consisting of CoPt and FeCoPt. One of sputter deposition, molecular beam deposition, and chemical vapor deposition is used for forming the magnetic layer 17.

Referring to FIG. 3E, a capping layer 19 is deposited on the magnetic layer 17. In this way, manufacturing of the patterned magnetic recording medium is completed.

As explained above, the magnetic layer 17 is formed on the buffer layer 11 and the nanowires 15 are uniformly grown on the buffer layer 11, so that nanometers magnetic dot patterns can be formed without using etching like in the related art magnetic recording medium. Thus, the entire manufacturing process can be simplified and the manufacturing costs can be reduced.

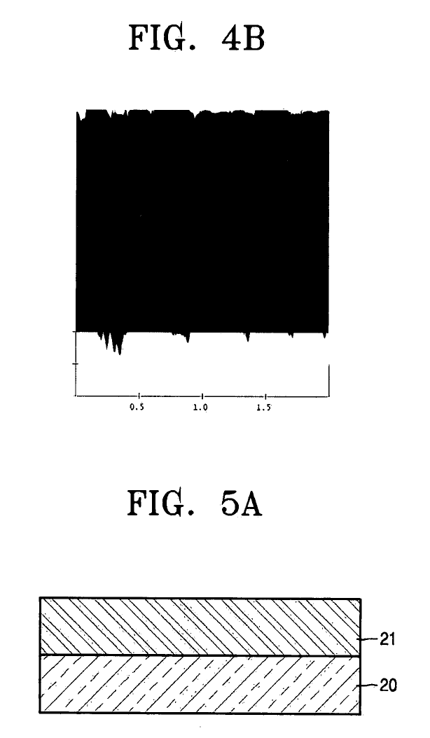

FIGS. 4A and 4B show intermediate results obtained after processes of FIGS. 3C and 3D, respectively. FIG. 4A shows the grown ZnO nanowires 15, and FIG. 4B shows the ZnO nanowires 15 after the magnetic layer 17 is formed on the ZnO nanowires 15 by sputter deposition. Although the contours of the nanowires 15 are less apparent in FIG. 4B than in FIG. 4A, portions of the magnetic layer 17 placed on the nanowires 15 are clearly distinguishable from other portions.

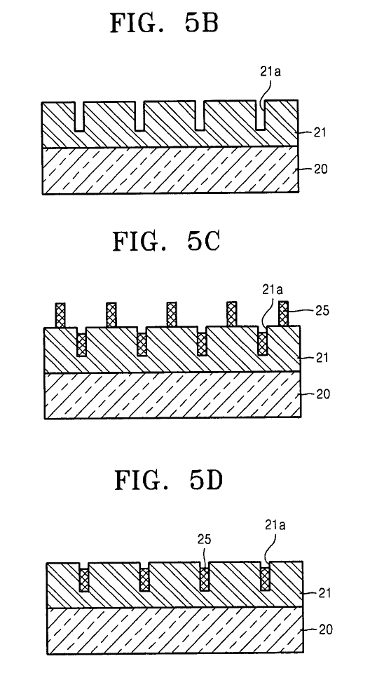

FIGS. 5A through 5E are views for illustrating a method of manufacturing the patterned magnetic recording medium of FIG. 2 according to an exemplary embodiment of the present invention. The current exemplary embodiment is substantially the same as the exemplary embodiment shown in FIGS. 3A through 3E except that trenches are formed in a buffer layer in a predetermined pattern so as to uniformly grow nanowires. Thus, only this difference will be described in detail.

Referring to FIG. 5A, a plate 20 is prepared as a base substrate of a magnetic recording medium, and a silicon (Si) buffer layer 21 is deposited on the plate 20.

Referring to FIG. 5B, the buffer layer 21 is patterned by etching along tracks of the patterned magnetic recording medium in order to form trenches 21a. Usually, the trenches 21a are formed in a circular pattern. The width of the trenches 21a is larger than the diameter of nanowires 25 (see FIG. 5C) to be grown in the trenches 21a.

Referring to FIG. 5C, the nanowires 25 are grown on the buffer layer 21 vertically. Here, the nanowires 25 are grown in the trenches 21a of the buffer layer 21 and the other surface of the buffer layer 21 in which the trenches 21a are not formed. Further, as described above, one or more nanowires 25 can be formed for each of the trenches 21a in a width direction of the trenches 21a.

Referring to FIGS. 5D and 5E, the nanowires 25 grown on the other surface of the buffer layer 21 where the trenches 21a are not formed are removed, and a top surface of the buffer layer 21 is etched to a predetermined depth to partially expose the nanowires 25 formed in the trenches 21a.

In this way, through the processes shown in FIGS. 5A through 5E, the nanowires 25 can be uniformly grown along the tracks of the patterned magnetic recording medium. After that, manufacturing of the patterned magnetic recording medium of FIG. 2 is completed through substantially the same processes of FIGS. 3C through 3E.

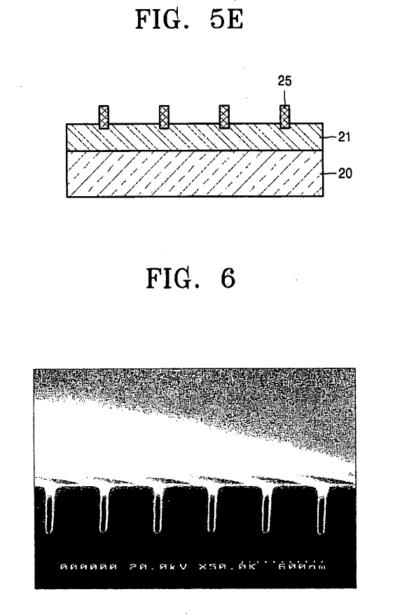

FIG. 6 shows an intermediate result obtained after a process of FIG. 5D is finished for the patterned magnetic recording medium. Referring to FIG. 6, the nanowires formed outside the trenches are removed, and thus the nanowires remain only in the trenches. The trenches have a depth of 600 nm, and a single nanowire is grown with respect to one trench. Although not clearly shown in FIG. 6, the nanowires are arranged in a row at uniform intervals of less than 40 nm along each of the tracks.

As mentioned above, the nanowires are formed at the trenches formed in the buffer layer, so that the nanowires can be formed more uniformly. Therefore, the magnetic domains of the patterned magnetic recording medium can be formed more uniformly.

As described above, the patterned magnetic recording medium and the method of manufacturing the patterned magnetic recording medium provide the following effects.

Etching is not used for patterning the magnetic layer, so that the manufacturing process can be simplified and manufacturing costs can be reduced when compared with the related art.

Further, the size of magnetic domains of the patterned magnetic recording medium can be reduced to nanometer level, thereby increasing the recording density of the patterned magnetic recording medium.

Furthermore, the recording density of the patterned magnetic recording medium can be easily adjusted by varying the size of the nanowires.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A patterned magnetic recording medium comprising:
a plate;
a plurality of nanowires formed on the plate; and
a magnetic layer patterned on the nanowires, the magnetic layer protruding in areas corresponding to the nanowires.

2. The patterned magnetic recording medium of claim 1, further comprising a buffer layer between the plate and the nanowires.

3. The patterned magnetic recording medium of claim 2, wherein the buffer layer is patterned along tracks of the patterned magnetic recording medium, and the nanowires are formed on the patterned buffer layer along the tracks.

4. The patterned magnetic recording medium of claim 1, wherein the nanowires have flattened leading ends.

5. The patterned magnetic recording medium of claim 1, further comprising a capping layer formed on the magnetic layer for protecting the magnetic layer.

6. The patterned magnetic recording medium of claim 1, wherein the magnetic layer comprises magnetic domains which have a size adjustable by varying the size of the nanowires.

7. The patterned magnetic recording medium of claim 1, wherein the nanowires are ZnO nanowires, carbon nanotubes, or silicon nanotubes.

8. The patterned magnetic recording medium of claim 1, wherein the magnetic layer is formed of an alloy containing at least one magnetic element and at least one non-magnetic element, the magnetic element including Fe and Co, and the non-magnetic element including Pt and Cr.

9. A method of manufacturing a patterned magnetic recording medium, the method comprising:
forming a plurality of nanowires on a plate; and
forming a magnetic layer on the nanowires.

10. The method of claim 9, wherein the forming of the nanowires comprises:
forming a buffer layer on the plate;
forming trenches in a top surface of the buffer layer in a pattern;
growing one or more of the nanowires in each of the trenches; and
removing nanowires grown on the buffer layer outside the trenches.

11. The method of claim 10, wherein the buffer layer is formed of silicon.

12. The method of claim 9, wherein the forming of the nanowires comprises flattening leading ends of the nanowires after the nanowires are grown.

13. The method of claim 12, wherein the leading ends of the nanowires are flattened by ion milling or laser trimming.

14. The method of claim 9, wherein the nanowires are ZnO nanowires, carbon nanotubes, or silicon nanotubes.

15. The method of claim 9, wherein the nanowires are grown on the plate by ALD (atomic layer deposition) or PECVD (plasma enhanced chemical vapor deposition).

16. The method of claim 9, wherein the magnetic layer is formed of an alloy containing at least one magnetic element and at least one non-magnetic element, the magnetic element including Fe and Co, the non-magnetic element including Pt and Cr.

17. The method of claim 9, wherein the magnetic layer is formed using one of sputter deposition, molecular beam deposition, and chemical vapor deposition.

18. The patterned magnetic recording medium of claim 1, wherein the plurality of nanowires are formed vertically on the plate.

19. The method of claim 9, wherein the growing the plurality of nanowires in the trenches comprises growing the plurality of nanowires vertically in the trenches.

20. The patterned magnetic recording medium of claim 3, wherein the buffer layer is patterned along the tracks of the patterned magnetic recording medium for forming trenches, and one or more of the nanowires are formed in each of the trenches.
